(19) United States
(12) Patent Application Publication
(10) Pub. No.: US 2021/0328304 A1
(43) Pub. Date: Oct. 21, 2021

(54) BATTERY PACK

(71) Applicant: CONTEMPORARY AMPEREX TECHNOLOGY CO., LIMITED, Ningde (CN)

(72) Inventors: Kaijie YOU, Ningde City (CN); Peng WANG, Ningde City (CN); Haizu JIN, Ningde City (CN); Dongyang SHI, Ningde City (CN); Zhenhua LI, Ningde City (CN); Ning CHEN, Ningde City (CN); Fei HU, Ningde City (CN)

(73) Assignee: CONTEMPORARY AMPEREX TECHNOLOGY CO., LIMITED, Ningde (CN)

(21) Appl. No.: 17/360,307

(22) Filed: Jun. 28, 2021

Related U.S. Application Data
(63) Continuation of application No. PCT/CN2019/079500, filed on Mar. 25, 2019.

(30) Foreign Application Priority Data
Dec. 28, 2018 (CN) 201822238925.6

(51) Int. Cl. H01M 50/383; H01M 50/342; H01M 50/209

(52) U.S. Cl. CPC H01M 50/383; H01M 50/209; H01M 50/3425

(57) ABSTRACT

The disclosure provides a battery pack, which includes a plurality of batteries and a box, the plurality of batteries accommodated in the box; each battery including an explosion-proof valve; the box including a lower box for supporting the batteries and an upper box matching the lower box, wherein the upper box includes an upper plate and a lower plate, the upper plate covers the lower plate to form an accommodating space for accommodating a fire extinguishing agent; the explosion-proof valve of each battery faces the lower plate of the upper box, and the lower plate is set to be able to discharge the fire extinguishing agent from the accommodating space after being melted. When the battery occurs a thermal runaway, the fire extinguishing agent in the lower plate flows rapidly to the runaway area, thus inhibiting the thermal runaway of the battery.

### CROSS-REFERENCE TO RELATED APPLICATIONS

This application is a continuation of International Application No. PCT/CN2019/079500, filed on Mar. 25, 2019, which claims priority to Chinese Patent Application No. 201822238925.6, filed on Dec. 28, 2018. The disclosures of the aforementioned applications are hereby incorporated by reference in their entireties.

### TECHNICAL FIELD

The disclosure relates to the field of batteries, and in particular, to a battery pack.

### BACKGROUND

In electric vehicles, a battery is a core component, and its safety has been widely concerned. The thermal runaway of a battery is extremely dangerous, threatening lives of passengers. And due to a huge impact of the thermal runaway, it may undermine consumer confidence in the electric vehicles. At present, in order to suppress the thermal runaway of the battery, a complicated fire extinguishing fluid pipeline is arranged in a battery pack, but it is difficult to design and assembly, and with a high cost and a low energy density. In addition, fire extinguishing fluid is kept in a free space inside the battery pack. In the process of running a vehicle, the fire extinguishing fluid can easily flow to all directions, and adhere to other parts, so that the effective fire extinguishing fluid in the battery pack become less and less, and at the moment of the thermal runaway, the fire extinguishing fluid may be located outside an area where a runaway occurs, as a result, a thermal runaway source cannot be effectively and timely extinguished or doused (for example, a high-temperature gas and/or flame generated inside the battery, the high-temperature gas may be doped with substances such as an electrolyte inside the battery). Refractories are arranged at and/or near an explosion-proof valve of the battery to resist the high-temperature and/or flame sprayed from the explosion-proof valve, but it is easy to make the thermal runaway diffuse in the battery pack, resulting in more and more battery thermal runaways, and increasing a risk of the thermal runaway.

### SUMMARY

In view of the deficiencies of the prior art, an objective of the disclosure is to provide a battery pack, which can ensure that a fire extinguishing agent quickly reaches a runaway area when a battery occurs a thermal runaway, and suppresses the thermal runaway of the battery.

In order to achieve the above objective, the disclosure provides a battery pack, which includes a plurality of batteries and a box, and the plurality of batteries are accommodated in the box; each battery includes an explosion-proof valve; the box includes a lower box for supporting the batteries and an upper box matching the lower box; the upper box includes an upper plate and a lower plate, the upper plate covers the lower plate to form an accommodating space for accommodating a fire extinguishing agent; the explosion-proof valve of the each battery faces the lower plate of the upper box, and the lower plate is set to be able to discharge the fire extinguishing agent from the accommodating space after being melted.

In one embodiment, the lower plate is provided with a weakened area, and the weakened area is opposite to the explosion-proof of the each battery.

In one embodiment, the plurality of batteries are set in rows, the lower plate is provided with the weakened area, and the weakened area covers an area formed by all explosion-proof valves of each battery row in a height direction.

In one embodiment, the weakened area is provided with a groove, so that a thickness of the weakened area is smaller than a thickness of other parts of the lower plate.

In one embodiment, the weakened area is provided with a score along its perimeter.

In one embodiment, the upper box further includes a partition wall, the accommodating space is divided into a plurality of accommodating cavities by the partition wall, and each accommodating cavity is opposite to the explosion-proof valve of the battery of each battery row V.

In one embodiment, the upper box further includes a fireproof plate, disposed between an inner surface of the upper plate and the fire extinguishing agent.

In one embodiment, the fireproof plate is a mica plate.

In one embodiment, thicknesses of the lower plate is smaller than thicknesses of the upper plate.

In one embodiment, the lower plate comprises: a bottom wall; a side wall, extending upward from all sides of the bottom wall; and a flange, extending outward from all sides of the side wall, and the flange is fixedly connected to an inner surface of the upper plate.

The advantageous effects of the disclosure are as follows: in the battery package of the disclosure, when the battery occurs the thermal runaway (a high-temperature gas generated inside the battery breaks through the explosion-proof of the battery and then is discharged from the battery, in which the high-temperature gas rushing out of the explosion-proof valve may be accompanied by a flame or doped with a high temperature electrolyte), the generated high-temperature gas and/or flame could melt through a position of the lower plate of the upper box corresponding to the explosion-proof valve, thereby forming a melted area that is melted through on the lower plate and causing the fire extinguishing agent in the lower plate to flow rapidly from the melted area to the runaway area. On the one hand, the fire extinguishing agent cools the high-temperature gas and/or extinguishes the flame, and on the other hand, the discharged fire extinguishing agent enters the explosion-proof valve to reduce the temperature of the battery, thus inhibiting the thermal runaway of the battery.

### BRIEF DESCRIPTION OF DRAWINGS

FIG. 1 is an exploded perspective view of a battery pack of the disclosure.

FIG. 2 is a sectional view of the battery pack in FIG. 1.

FIG. 3 is an enlarged view of a part A in FIG. 2, which shows a state of a discharged fire extinguishing agent after a lower plate is melted.

FIG. 4 is an exploded perspective view of an upper box of the battery pack in FIG. 1.

FIG. 5 is a perspective view of an upper cover of the battery pack in FIG. 1 from another angle.

FIG. 6 is a partial cross-sectional view of the upper box of the battery pack in FIG. 5.

FIG. 7 is a perspective view of the first embodiment of the upper box of the battery pack of the disclosure.

FIG. 8 is a perspective view of the second embodiment of the upper box of the battery pack of the disclosure.

FIG. 9 is a perspective view of the third embodiment of the upper box of the battery pack of the disclosure.

FIG. 10 is a perspective view of the fourth embodiment of the upper box of the battery pack of the disclosure.

FIG. 11 is a perspective view of the fifth embodiment of the upper box of the battery pack of the disclosure.

FIG. 12 is a perspective view of the sixth embodiment of the upper box of the battery pack of the disclosure.

Reference signs are explained as follows:

```
  1 battery
  11 explosion-proof valve
  12 pole
  2 box
  21 lower box
211 first edge portion
  22 upper box
221 upper plate
222 lower plate
222A weakened area
222B bottom wall
222C side wall
222D flange
223 partition wall
224 fireproof plate
225 second edge portion
  3 fire extinguishing agent
S accommodating space
Si accommodating cavity
R groove
V battery row
M melted area
H height direction
L length direction
W width direction
```

### DESCRIPTION OF EMBODIMENTS

Embodiments of the disclosure are shown in the drawings. Moreover, it will be appreciated that the disclosed embodiments are merely examples of the disclosure. The disclosure may be implemented in various forms. Therefore, specific details disclosed herein are not to be interpreted as limiting, but merely as a basis of claims, and as a representative basis for teaching those skilled in the art to implement the disclosure in various ways.

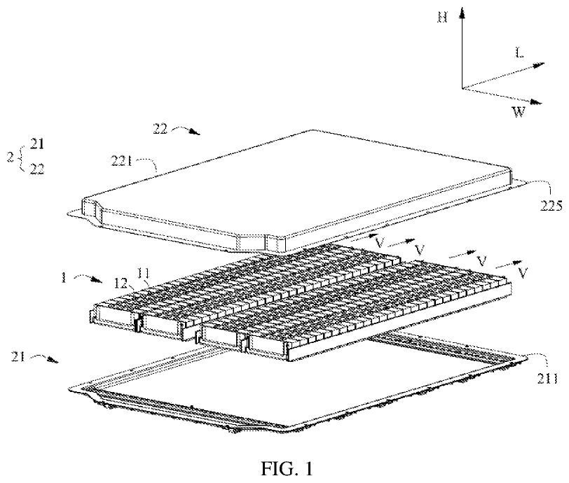

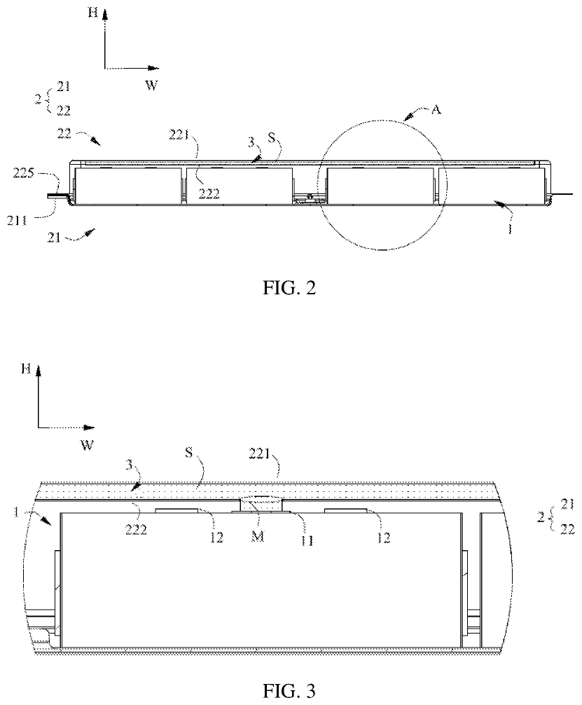

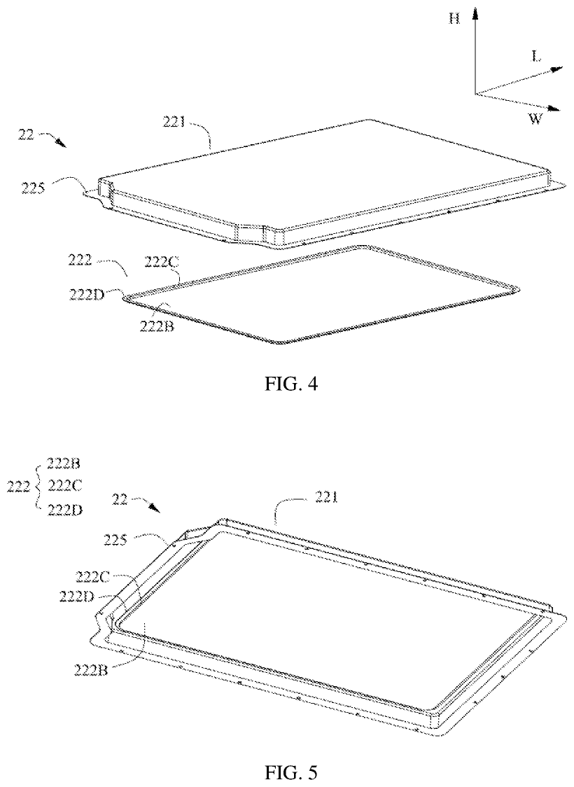

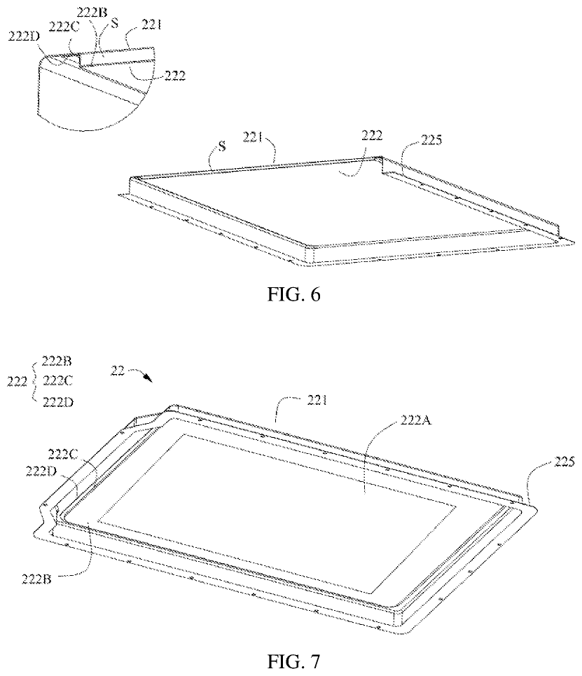

FIG. 1 is an exploded perspective view of a battery pack of the disclosure. FIG. 2 is a sectional view of the battery pack in FIG. 1. FIG. 3 is an enlarged view of a part A in FIG. 2, which shows a state of a discharged fire extinguishing agent after a lower plate is melted. FIG. 4 is an exploded perspective view of an upper box of the battery pack in FIG. 1. FIG. 5 is a perspective view of an upper cover of the battery pack of FIG. 1 from another angle. FIG. 6 is a partial cross-sectional view of the upper box of the battery pack in FIG. 5.

The battery pack of the disclosure includes a plurality of batteries 1 and a box 2, and the plurality of batteries 1 are accommodated in the box 2; each battery 1 includes an explosion-proof valve 11; the box 2 includes a lower box 21 for supporting batteries 1 and an upper box 22 matching the lower box 21; the upper box 22 includes an upper plate 221 and a lower plate 222, the upper plate 221 covers the lower plate 222 to form an accommodating space S for accommodating a fire extinguishing agent 3; the explosion-proof valve 11 of each battery 1 faces the lower plate 222 of the upper box 22, and the lower plate 222 is set to be able to discharge the fire extinguishing agent 3 from the accommodating space S after being melted. The lower box 21 includes a first edge portion 211, the upper box 22 includes a second edge portion 225, and the first edge portion 211 is connected to the second edge portion 225. The first edge portion 211 and the second edge portion 225 can be connected by such ways as rivet connection, bolt connection, buckle connection, or glue connection.

In the battery pack of the disclosure, with reference to FIGS. 1 to 3, when the battery 1 occurs a thermal runaway (a high-temperature gas generated inside the battery 1 breaks through the explosion-proof 11 of the battery 1 and then is discharged from the battery 1, in which the high-temperature gas rushing out of the explosion-proof valve 11 may be accompanied by a flame or doped with a high temperature electrolyte), the generated high-temperature gas and/or the flame could melt through a position of the lower plate 222 of the upper box 22 corresponding to the explosion-proof valve 11, thereby forming a melted area M that is melted through on the lower plate 222 and causing the fire extinguishing agent 3 in the lower plate 222 to flow rapidly from the melted area M to a runaway area. On the one hand, the fire extinguishing agent 3 cools the high-temperature gas and/or extinguishes the flame, and on the other hand, the discharged fire extinguishing agent 3 enters the explosion-proof valve 11 to reduce the temperature of the battery 1, thus inhibiting the thermal runaway of the battery.

The battery 1 is a hard shell battery (or referred to a can-type battery), including an electrode assembly (not shown), a housing, a top cover, the explosion-proof valve 11 and a pole 12. An accommodating cavity is formed inside the housing to accommodate the electrode assembly and an electrolyte. The electrode assembly includes a positive electrode plate, a negative electrode plate and a separator separating the positive electrode plate and the negative electrode plate. The electrode assembly can be formed by winding the positive electrode plate, the negative electrode plate and the separator, or stacking the positive electrode plate, the negative electrode plate and the separator. Both the positive electrode plate and the negative electrode plate include a current collector, and an active material layer disposed on the current collector.

With reference to FIGS. 4 to 11, the lower plate 222 includes: a bottom wall 222B; a side wall 222C, extending upward from all sides of the bottom wall 222B; and a flange 222D, extending outward from all sides of the side wall 222C, and the flange 222D is fixedly connected to an inner surface of the upper plate 221. The flange 222D can be fixedly connected to the inner surface of the upper plate 221 by means of screw connection, bolt connection, rivet connection or glue connection for sealing and fixing.

The material of the lower plate 222 can be a material with a melting point of 200˜500° C., such as aluminum, to ensure that the lower plate 222 can be timely melted through and discharge the fire extinguishing agent 3 when the battery 1 occurs the thermal runaway, so that the fire extinguishing agent 3 can quickly flow to the runaway area to inhibit the thermal runaway.

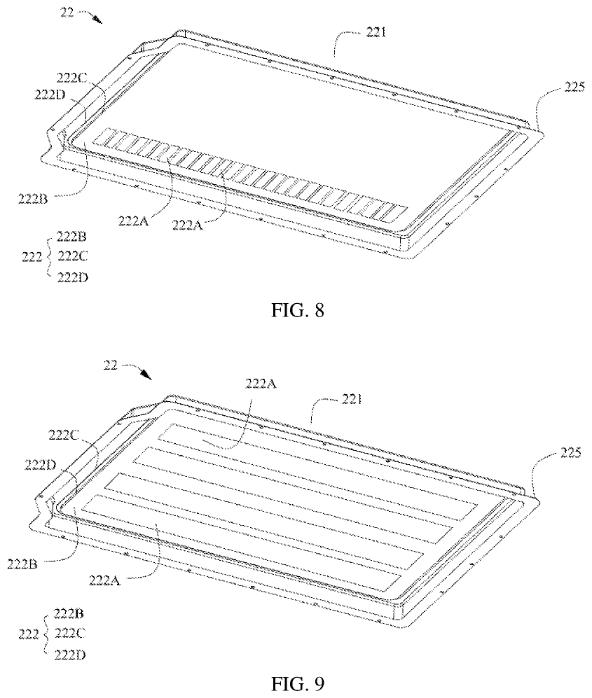

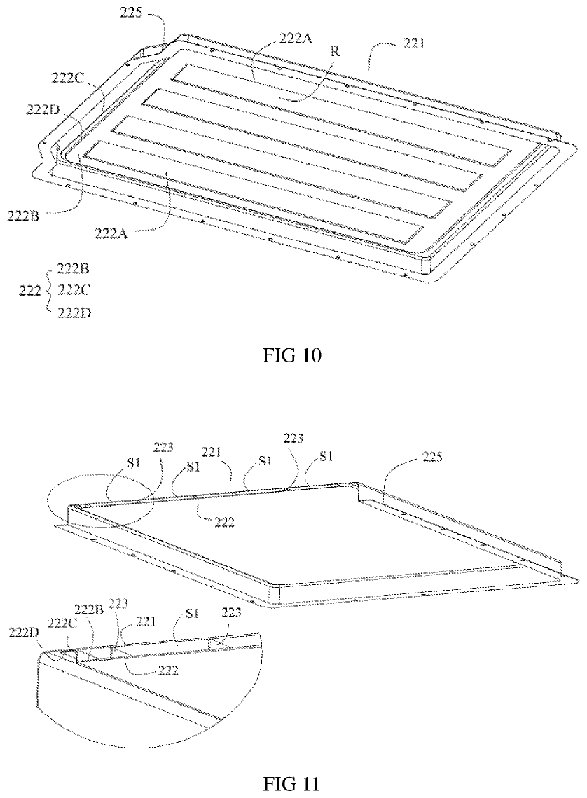

FIG. 7 is a perspective view of the first embodiment of the upper box of the battery pack of the disclosure. FIG. 8 is a perspective view of the second embodiment of the upper box of the battery pack of the disclosure. FIG. 9 is a perspective view of the third embodiment of the upper box of the battery pack of the disclosure. FIG. 10 is a perspective view of the fourth embodiment of the upper box of the battery pack of the disclosure.

With reference to the embodiments shown in FIGS. 7 to 10, in order to further ensure that the lower plate 222 fully functions, the lower plate 222 is provided with a weakened area 222A, and the weakened area 222A is opposite to the explosion-proof 11 of each battery 1. The number of the weakened areas 222A can be one or multiple. According to the first embodiment shown in FIG. 7, the lower plate 222 is provided with one weakened area 222A, which covers an area formed by the explosion-proof valves 11 of all the batteries 1, without setting multiple weakened areas 222A, to reduce procedures of processing the lower plate 222. According to the second embodiment shown in FIG. 8, the lower plate 222 is provided with multiple weakened areas 222A, and each weakened area 222A covers an area formed by the explosion-proof valve 11 of each battery 1 (for clarity, only a part of the weakened areas 222A shown in FIG. 8). Each weakened area 222A corresponding to each explosion-proof valve 11 is separated to avoid unnecessary waste caused by excessive diffusion of a melted area M and excessive discharge of the fire extinguishing agent 3 due to the fusibility of the weakened area 222A. According to the third embodiment shown in FIG. 9, multiple batteries 1 are set in rows. The weakened area 222A is disposed on the lower plate 222 on the basis of battery row V, which covers an area formed by all explosion-proof valves 11 of each battery row V in a height direction. The row number of the battery rows V corresponding to the weakened area 222A is not limited and can be set flexibly. Multiple weakened areas 222A can be arranged on the lower plate 222, one weak area 222A corresponds to multiple battery rows V, and the set number of the weakened areas 222A can be selected according to specific needs. According to the fourth embodiment shown in FIG. 10, the weakened area 222A can be provided with a groove R so that a thickness of the weakened area 222A is smaller than a thickness of other parts of the lower plate 222, so as to ensure that the weakened area 222A corresponding to the explosion-proof valve 11 of the battery 1 occurring the thermal runaway quickly melts and discharges the fire extinguishing agent 3 in a short time. In order to ensure that the weakened area 222A is smoothly broken through, the weakened area 222A is provided with a score (not shown) along its perimeter. The groove R or the score are provided to enhance the effect of the weakened area 222A, so as to ensure that the lower plate 222 fully functions.

FIG. 11 is a perspective view of the fifth embodiment of the upper box of the battery pack of the disclosure.

With reference to the fifth embodiment shown in FIG. 11, the upper box 22 further includes a partition wall 223, the accommodating space S is divided into a plurality of accommodating cavities S1 by the partition wall 223, each accommodating cavity S1 is opposite to the explosion-proof valves 11 of the batteries 1 of each battery row V for separate management. Since a thermal runaway chain reaction is most likely to occur between the batteries 1 of each battery row V, the corresponding accommodating cavity S1 is respectively disposed on the lower plate 222 for each battery row V, so that the fire extinguishing agent 3 in each accommodating cavity S1 mainly deals with the thermal runaway of the corresponding battery row V, and the fire extinguishing agent 3 can quickly flow to a thermal away area.

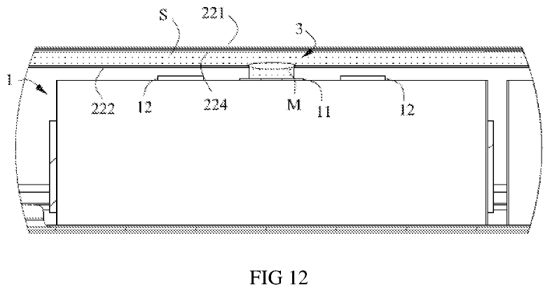

FIG. 12 is a perspective view of the sixth embodiment of the upper box of the battery pack of the disclosure.

According to the sixth embodiment shown in FIG. 12, the upper box 22 can further include a fireproof plate 224 disposed between the inner surface of the upper plate 221 and the fire extinguishing agent 3 to extend the time before the high-temperature gas and/or flame sprayed out when the battery 1 occurs the thermal runaway burn through the upper plate 221, so that the fire extinguishing agent 3 has enough time to fully cool down and extinguish the fire. And it can also be realized by designing thickness of the lower plate 222 to be smaller than thickness of the upper plate 221. Among them, the fireproof board 224 can be selected from a mica plate, which has a high melting point and a high temperature resistance. The fireproof board 224 can be fixed on the inner surface of the upper plate 221.

The fire extinguishing agent 3 can be a dry powder fire extinguishing agent or can choose a fire extinguishing fluid with high latent heat, high specific heat capacity and good insulation.

The above detailed description describes a number of exemplary embodiments, but is not intended to be limited to an explicitly disclosed combination. Therefore, unless otherwise stated, various features disclosed herein can be grouped together to form multiple additional combinations which for the purpose of brevity are not shown.

The above descriptions are only preferred embodiments of the present application, and are not intended to limit the present application. For those skilled in the art, the present application can have various modifications and changes. Any modification, equivalent replacement, improvement, or the like made within the spirit and principle of this application shall fall within the protection scope of this application.

What is claimed is:

1. A battery pack, comprising:
a plurality of batteries and a box, wherein
the plurality of batteries are configured to accommodate in the box; and
each of the plurality of batteries comprises an explosion-proof valve;
the box comprises a lower box and an upper box matching the lower box, wherein the lower box is configured to support the plurality of batteries,
wherein the upper box comprises an upper plate and a lower plate, the upper plate is configured to cover the lower plate to form an accommodating space for accommodating a fire extinguishing agent;
the explosion-proof valve is configured to face the lower plate of the upper box, wherein the lower plate is configured to discharge the fire extinguishing agent from the accommodating space after the lower plate being melted.

2. The battery pack according to claim 1, wherein the lower plate is provided with at least one weakened area, and each of the at least one weakened area is configured to be opposite to explosion-proof valve of at least one of the plurality of batteries.

3. The battery pack according to claim 2, wherein the each of the at least one weakened area is provided with a groove, so that a thickness of the each of the at least one weakened area is smaller than a thickness of other parts of the lower plate.

4. The battery pack according to claim 2, wherein along perimeter of the each of the at least one weakened area, a score is provided.

5. The battery pack according to claim 2, wherein the lower plate is provided with one weakened area, the one weakened area is configured to be opposite to all explosion-proof valves of the plurality of batteries.

6. The battery pack according to claim 5, wherein the one weakened area is provided with a groove, so that a thickness of the one weakened area is smaller than a thickness of other parts of the lower plate.

7. The battery pack according to claim 5, wherein along perimeter of the one weakened area, a score is provided.

8. The battery pack according to claim 2, wherein the lower plate is provided with a plurality of weakened areas, and each of the plurality of weakened areas is configured to be opposite to an explosion-proof valve of one of the plurality of batteries.

9. The battery pack according to claim 8, wherein the each of the plurality of weakened areas is provided with a groove, so that a thickness of the each of the plurality of weakened areas is smaller than a thickness of other parts of the lower plate.

10. The battery pack according to claim 8, wherein along perimeter of the each of the plurality of weakened areas, a score is provided.

11. The battery pack according to claim 1, wherein the plurality of batteries are set to multiple battery rows, the lower plate is provided with a plurality of weakened areas, and each of the plurality of weakened areas is configured to cover an area formed by explosion-proof valves of one of the multiple battery rows in a height direction.

12. The battery pack according to claim 11, wherein the each of the plurality of weakened areas is provided with a groove, so that a thickness of the each of the plurality of weakened area is smaller than a thickness of other parts of the lower plate.

13. The battery pack according to claim 11, wherein along perimeter of the each of the plurality of weakened areas, a score is provided.

14. The battery pack according to claim 11, wherein the upper box further comprises a partition wall, the accommodating space is divided into a plurality of accommodating cavities by the partition wall.

15. The battery pack according to claim 14, wherein each of the plurality of accommodating cavities is configured to be opposite to the explosion-proof valves of one of the multiple battery rows.

16. The battery pack according to claim 1, wherein the upper box further comprises a fireproof plate disposed between an inner surface of the upper plate and the fire extinguishing agent.

17. The battery pack according to claim 16, wherein the fireproof plate is a mica plate.

18. The battery pack according to claim 1, wherein a thickness of the lower plate is smaller than a thickness of the upper plate.

19. The battery pack according to claim 1, wherein the lower plate comprises:
a bottom wall;
a side wall, extending upward from all sides of the bottom wall; and
a flange, extending outward from all sides of the side wall, and the flange is fixedly connected to an inner surface of the upper plate.

20. The battery pack according to claim 19, wherein the flange is fixedly connected to the inner surface of the upper plate by means of screw connection, bolt connection, rivet connection or glue connection.
